(19) United States
(12) Patent Application Publication
(10) Pub. No.: US 2021/0086485 A1
(43) Pub. Date: Mar. 25, 2021

(54) MULTI-LAYERED MOTOR VEHICLE TUBE

(71) Applicant: TI Automotive (Fuldabrück) GmbH, Fuldabruck (DE)

(72) Inventors: Werner Zimmer, Melsungen/Roehrenfurth (DE); Frank Fahrenholz, Kassel (DE); Siegfried Arnold, Kassel (DE); Martin Schramowski, Kassel (DE)

(21) Appl. No.: 16/975,040

(22) PCT Filed: Feb. 21, 2019
(86) PCT No.: PCT/IB2019/051436

§ 371 Date: Aug. 21, 2020

(30) Foreign Application Priority Data
Feb. 22, 2018 (EP) 18158180.2

(51) Int. Cl. B32B 27/08; B32B 1/08; B32B 7/12; B32B 27/34

(52) U.S. Cl. CPC B32B 27/08; B32B 1/08; B32B 27/306; B32B 27/34; B32B 7/12

(57) ABSTRACT

Multilayered motor vehicle tube, wherein the tube has at least five layers with the following layer structure from the outside to the inside:
An outer layer made of at least one polymer from the group “polyamide, polyolefin,”
a first carrier layer made of polyamide,
a barrier layer made of at least one component from the group “ethylene vinyl alcohol copolymer (EVOH), fluoropolymer,”
a second carrier layer made of polyamide,
an inner layer made of a thermoplastic polyurethane (TPU).

The total layer thickness of the tube is 0.7 to 2 mm.

### RELATED APPLICATIONS

The present patent document claims priority to PCT Application PCT/IB2019/051436, filed Feb. 21, 2019 which claims the benefit of and priority to European Patent Application 18 158 180.2, filed Feb. 22, 2018, and entitled “Multi-Layered Motor Vehicle Tube” the entire contents of which are incorporated herein by reference.

### FIELD

The disclosure relates to a multilayered motor vehicle tube, particularly for conducting fuels, wherein the tube has at least five layers. The multilayered motor vehicle tube according to the disclosure is used particularly as a fuel tube in vehicles. The motor vehicle tube can also be used as a vent line in tank venting systems. In such case, particularly fuel vapors and their condensates are applied to the tube.

### BACKGROUND

Multilayered motor vehicle tubes of the aforementioned type are known from practice in different embodiments. Many of these known tubes have the disadvantage that the tube layers are subject to unwanted erosions of layer components. This relates particularly to the inner layer, which is in contact with the fuel, but also to the adjacent middle layers. The inner layers frequently contain small quantities of oligomers which can be eroded by the fuel and subsequently condense in the fuel system, where they can cause problems, particularly for nozzles and the like. In respect of their fuel stability or in respect of their resistance to the fuels, the known tubes leave much to be desired. Not least because of this reason, the barrier properties of these known tubes also do not meet all requirements. It has already been attempted to solve this problem by varying the layers—particularly the inner layers. However, improvements with regard to unwanted erosions were made at the expense of the mechanical resilience and/or the thermal resistance of the tubes. Due to the material selection, many of these known tubes can additionally only be produced at high costs. This applies particularly for motor vehicle tubes with inner layers made of fluoropolymers, particularly made of ETFE. ETFE is further disadvantageous because in case of fire, it can result in hazardous or unhealthy fluorine compounds.

### SUMMARY

In comparison, the disclosure addresses the technical problem of providing a multilayered motor vehicle tube of the initially described type, with which the aforementioned disadvantages can be prevented, which has an improved chemical resistance or resistance against erosions as well as a sufficiently mechanical resilience and an optimal resistance against different temperatures, particularly higher temperatures. In addition, the tube is supposed to be producible as cost-efficiently as possible.

For solving the technical problem, the disclosure teaches a multilayered motor vehicle tube, particularly for conducting fuels, wherein the tube has at least five layers with the following layer structure from the outside to the inside:
An outer layer made of at least one polymer from the group “polyamide, polyolefin,”
a first carrier layer made of polyamide,
a barrier layer made of at least one component from the group “ethylene vinyl alcohol copolymer (EVOH), fluoropolymer,”
a second carrier layer made of polyamide,
an inner layer made of a thermoplastic polyurethane (TPU),

wherein the total layer thickness of the tube is 0.7 to 2.5 mm, particularly 0.8 to 2 mm, and preferably 0.85 to 1.8 mm. Particularly preferably, the total layer thickness of the tube is between 0.85 and 1.7 mm.

According to a recommended embodiment of the disclosure, the outer layer of the tube consists of polyamide 12 or substantially of polyamide 12. Another recommended embodiment of the disclosure is characterized in that the outer layer consists of polyethylene or substantially of polyethylene. Particularly preferably, the outer layer consists of HDPE or substantially of HDPE. It is recommended that the thickness of the outer layer is 5% to 60%, particularly 7% to 45%, and preferably 10% to 40% of the total wall thickness of the tube. It lies within the scope of the disclosure that the thickness of the outer layer is maximally 0.4 mm and preferably lies in the range between 0.1 and 0.4 mm, very preferably in the range between 0.2 and 0.4 mm.

A particular recommended embodiment of the disclosure is characterized in that at least one adhesion promoting layer and preferably one adhesion promoting layer is interposed between the outer layer and the first carrier layer. Preferably, an adhesion promoting layer on the basis of polyamide or on the basis of a polyolefin is used. If an adhesion promoting layer on the basis of polyamide is used, it is preferably a modified polyamide, preferably a modified polyamide on the basis of polyamide 612. If an adhesion promoting layer on the basis of a polyolefin is used, it is preferably a polyolefin modified with a carboxylic acid derivative, preferably with a maleic acid, and very preferably with a maleic acid derivative, particularly polyethylene. Expediently, the thickness of the adhesion promoting layer is 3% to 30%, particularly 5% to 20%, and preferably 5% to 15% of the total wall thickness of the tube. Expediently, the thickness of the adhesion promoting layer is 0.03 to 0.15 mm and preferably 0.03 to 0.1 mm.

A very recommended embodiment of the disclosure is characterized in that the first carrier layer consists of polyamide 6 or substantially of polyamide 6. The first carrier layer can basically also consist of or substantially consist of at least one or one polyamide from the group “polyamide 612, polyamide 12, polyamide 10, polyamide 11, co-polyamide 6/6.6, co-polyamide 6/12”. It lies within the scope of the disclosure that the thickness of the first carrier layer is 5% to 70%, particularly 10% to 60%, and preferably 15% to 60% of the total wall thickness of the tube. Expediently, the thickness of the first carrier layer is at least twice as thick and preferably at least 3 times as thick as the thickness of the adhesion promoting layer. It is recommended that the thickness of the first carrier layer is 0.1 to 0.8 mm, particularly 0.1 to 0.75 mm, and preferably 0.2 to 0.6 mm. According to a proven embodiment of the disclosure, the first carrier layer is thicker than the barrier layer and preferably at least twice as thick as the barrier layer. According to a design variation of the disclosure, the first carrier layer is at least 2.5 times as thick as the barrier layer. It lies within the scope of the disclosure that the first carrier layer is thicker than the outer layer and is recommended to be at least 1.5 times thicker than the outer layer.

One embodiment, which is of particular importance within the scope of the disclosure, is characterized in that the barrier layer consists of ethylene vinyl alcohol copolymer (EVOH) or substantially consists of EVOH. In combination with the further layers according to the disclosure, this material has proven to be particularly successful as the barrier layer. It lies within the scope of the disclosure that the thickness of the barrier layer is 5% to 50%, particularly 5% to 45%, and preferably 10% to 40% of the total wall thickness of the tube. Expediently, the thickness of the barrier layer is 0.05 to 0.4 mm, particularly 0.05 to 0.3 mm, and preferably 0.75 to 0.25 mm.

A particularly preferred embodiment of the disclosure is characterized in that the second carrier layer consists of polyamide 6 or substantially consists of polyamide 6. The second carrier layer can basically also consist of or substantially consist of at least one or one polyamide from the group “polyamide 612, polyamide 12, polyamide 10, polyamide 11, co-polyamide 6/6.6, co-polyamide 6/12.” It lies within the scope of the disclosure that the thickness of the second carrier layer is 5% to 70%, particularly 10% to 60%, and preferably 15% to 60%, and very preferably 15% to 55% of the total wall thickness of the tube. Expediently, the thickness of the second carrier layer is 0.1 to 0.8 mm, particularly 0.1 to 0.75 mm, and preferably 0.2 to 0.6 mm. It is recommended that the second carrier layer is thicker than the barrier layer and preferably at least twice as thick as the barrier layer. According to a design variation of the disclosure, the second carrier layer is at least 2.5 times as thick as the barrier layer. It furthermore lies within the scope of the disclosure that the second carrier layer is thicker than the outer layer and is preferably at least 1.5 times thicker than the outer layer.

According to the disclosure, the inner layer consists of a thermoplastic polyurethane (TPU). With regard to the solution of the technical problem, this material has proven to be particularly successful. With regard to the components of the fuel or fuel vapor flowing through the tube, this inner layer acts as a barrier layer, as it were, and is characterized by a very low erosion of layer components. It lies within the scope of the disclosure that the thickness of the inner layer is 5% to 55%, particularly 7% to 50%, and preferably 10% to 40% of the total wall thickness of the tube. Expediently, the thickness of the inner layer is 0.05 to 0.45 mm, particularly 0.05 to 0.4 mm, and preferably 0.1 to 0.35 mm. It lies within the scope of the disclosure that the thickness of the inner layer is smaller than the thickness of the first carrier layer and/or the thickness of the second carrier layer. According to a design variation of the disclosure, the inner layer is designed as an electrically conducting layer and for that purpose provided with conductivity additives.

A particularly recommended embodiment of the disclosure is characterized in that the first carrier layer and/or the second carrier layer has a greater thickness than the barrier layer. For that purpose, the first carrier layer and/or the second carrier layer is expediently at least 1.2 times, particularly at least 1.5 times, and preferably at least 1.8 times thicker than the barrier layer. According to a very preferred embodiment of the disclosure, the first carrier layer and/or the second carrier layer has a greater thickness than the inner layer. Expediently, the first carrier layer and/or the second carrier layer is at least 1.2 times, particularly at least 1.4 times, and preferably at least 1.5 times thicker than the inner layer. It lies within the scope of the disclosure that the outer layer has a greater thickness than the barrier layer. Particularly, the outer layer is at least 1.1 times, and preferably at least 1.2 times thicker than the barrier layer. According to a recommended embodiment of the disclosure, the first carrier layer and/or the second carrier layer is thicker than the outer layer. Particularly, the first carrier layer and/or the second carrier layer is at least 1.2 times, and preferably at least 1.3 times thicker than the outer layer.

It lies within the scope of the disclosure that the outer layer ensures optimal protection against environmental influences. It is corrosion-resistant against splash water, particularly salt water, and chemically resistant against oil and fuel. The two carrier layers ensure particularly the mechanical stability of the tube according to the disclosure. Similar to the barrier layer, the inner layer has a barrier effect, particularly against the components of the fuel or fuel vapor flowing through the tube.

According to a preferred embodiment of the disclosure, the motor vehicle tube according to the disclosure is produced by means of extrusion or coextrusion of the layers. The layer components according to the disclosure allow for a very simple coextrusion, and above all, the coextrusion can be performed at moderate temperatures. Moreover, the tube according to the disclosure can also be designed as a smooth unprofiled pipe or also as a corrugated pipe.

The disclosure is based on the realization that the motor vehicle tube according to the disclosure has an excellent chemical resistance and is particularly resistant against erosions of layer components. This applies particularly to the inner layer but also to the adjacent layers. The tube according to the disclosure has optimal barrier properties and a very good fuel and aging resistance. It is of particular advantage that one and the same tube according to the disclosure can be used for different types of fuel and maintains the aforementioned advantages with said different types of fuel. It must be noted that the tube according to the disclosure, in addition to the described chemical resistance, also has an excellent mechanical resilience. Furthermore, the tube according to the disclosure is characterized by an optimal thermal resistance, and the tube can be used without problems in a temperature range between −40° C. and 140° C. When compared to many previously known tubes, the tube according to the disclosure is additionally also very cost-efficient or can be produced from very cost-efficient materials. It must further be noted that the materials of the layers of the tube according to the disclosure can be very easily processed, and above all, a simple and problem-free coextrusion of the layer sequence according to the disclosure is possible.

In the following, the disclosure shall be explained in more detail using embodiments:

According to a first embodiment, the outer layer of the tube according to the disclosure consists of polyamide 12 or substantially of polyamide 12, and said outer layer preferably has a thickness of 0.15 to 0.35 mm. The outer layer is preferably directly followed on the inner side by an adhesion promoting layer which preferably consists of a polyamide modified with maleic acid anhydride, particularly polyamide 612. Expediently, the adhesion promoting layer has a thickness from 0.03 to 0.1 mm. This adhesion promoting layer is immediately followed on the inner side by the first carrier layer which consists of polyamide 6 or substantially of polyamide 6. It preferably has a layer thickness from 0.2 to 0.75 mm. On the inner side, the first carrier layer is directly followed by the barrier layer which consists of EVOH or substantially of EVOH and preferably has a layer thickness from 0.05 to 0.3 mm. The barrier layer is directly followed on the inner side by the second carrier layer which consists of polyamide 6 or substantially of polyamide 6, and preferably has a layer thickness from 0.2 to 0.75 mm. On the inner side, the second carrier layer is followed by the inner layer which consists of TPU or substantially of TPU and preferably has a layer thickness from 0.05 to 0.4 mm. The total wall thickness of this tube preferably lies in the range between 0.7 and 2 mm.

According to a second embodiment of the disclosure, the outer layer consists of HDPE or substantially of HDPE and expediently has a layer thickness from 0.2 to 0.4 mm. According to a preferred embodiment, the outer layer is directly followed on the inner side by an adhesion promoting layer which preferably consists or substantially consists of a polyamide modified with maleic acid anhydride and preferably has a layer thickness from 0.03 mm to 0.1 mm. The adhesion promoting layer is immediately followed on the inner side by the first carrier layer which consists of polyamide 6 or substantially of polyamide 6 and preferably has a layer thickness from 0.2 to 0.75 mm. On the inner side, the first carrier layer is directly followed by the barrier layer which consists of EVOH or substantially of EVOH and preferably has a layer thickness from 0.05 to 0.3 mm. The barrier layer is directly followed on the inner side by the second carrier layer which consists of polyamide 6 or substantially of polyamide 6, and preferably has a layer thickness from 0.2 to 0.75 mm. The second carrier layer is directly followed on the inner side by the inner layer which consists of TPU or substantially of TPU and preferably has a layer thickness from 0.1 to 0.4 mm. The total wall thickness of this tube preferably lies in the range between 0.8 and 2 mm.

### BRIEF DESCRIPTION OF THE DRAWINGS

In the following, the disclosure shall be explained in more detail using a drawing showing only one embodiment. It is shown schematically in:

FIG. 1 a perspective view of a tube according to the disclosure, and

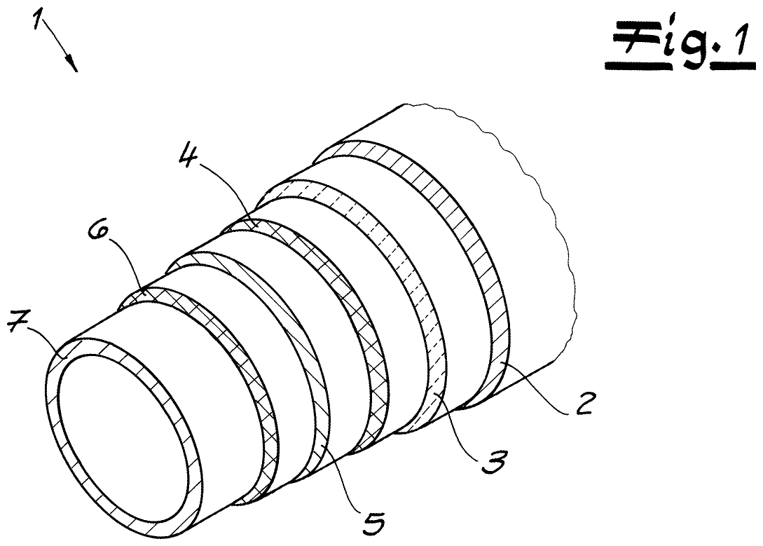

FIG. 2 a cutaway view of the subject matter according to FIG. 1.

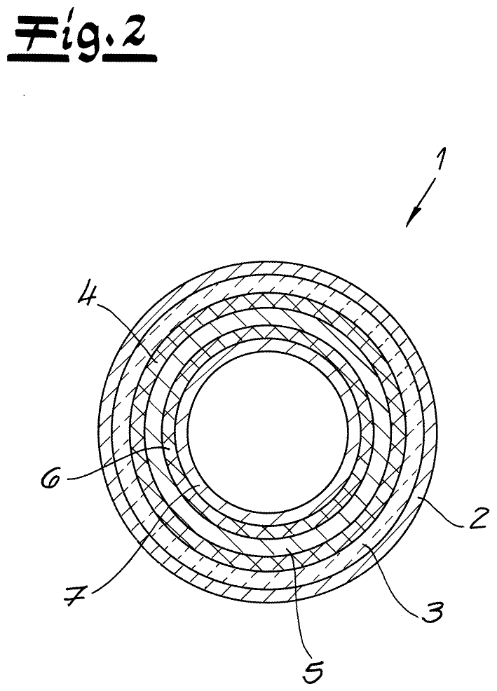

### DETAILED DESCRIPTION

In the embodiment according to the drawings, the tube 1 according to the disclosure has an outer layer 2 which consists of polyamide 12 or substantially of polyamide 12 and preferably has a layer thickness between 0.2 and 0.4 mm. This outer layer 2 is followed on the inner side by an adhesion promoting layer 3 which preferably and in the embodiment consists of polyamide 612 modified with maleic acid anhydride. This is followed on the inner side by the first carrier layer 4 which preferably and in the embodiment consists of polyamide 6 or substantially of polyamide 6 and expediently has a layer thickness between 0.2 and 0.75 mm. On the inner side, this first carrier layer 4 is followed by the barrier layer 5 which preferably and in the embodiment consists of EVOH or substantially of EVOH and preferably has a layer thickness between 0.1 and 0.3 mm. This barrier layer 5 is followed on the inner side by the second carrier layer 6 which consists of polyamide 6 or substantially of polyamide 6 and preferably has a layer thickness between 0.2 and 0.75 mm. On the inner side, the second carrier layer 6 is followed by the inner layer 7 which consists of TPU or substantially of TPU and preferably has a layer thickness between 0.1 and 0.4 mm. The motor vehicle tube 1 shown in the drawings was produced by means of coextrusion. It lies within the scope of the disclosure that the inner layer 7 can be provided with conductivity additives.

1. Multilayered motor vehicle tube for conducting fuels, wherein the tube has at least five layers with the following layer structure from outside to inside:
an outer layer made of at least one polymer from the group “polyamide, polyolefin,”
a first carrier layer made of polyamide,
a barrier layer made of at least one component from the group “ethylene vinyl alcohol copolymer (EVOH), fluoropolymer,”
a second carrier layer made of polyamide, and
an inner layer made of a thermoplastic polyurethane (TPU),
wherein the total layer thickness of the tube is 0.7 to 2.5 mm.

2. Tube according to claim 1, wherein the outer layer consists substantially of polyamide 12.

3. Tube according to claim 1, wherein the outer layer substantially consists of HDPE.

4. Tube according to claim 1, wherein the thickness of the outer layer is 5% to 60%, preferably 7% to 45% of the total wall thickness of the tube.

5. Tube according to claim 1, wherein at least one adhesion promoting is interposed between the outer layer and the first carrier layer.

6. Tube according to claim 5, wherein the thickness of the adhesion promoting layer is 3% to 30% of the total wall thickness of the tube.

7. Tube according to claim 1, wherein the first carrier layer consists substantially of polyamide 6.

8. Tube according to claim 1, wherein the first carrier layer substantially consists of at least one polyamide from the group “polyamide 612, polyamide 12, polyamide 10, polyamide 11, co-polyamide 6/6.6, co-polyamide 6/12.”

9. Tube according to claim 1, wherein the thickness of the first carrier layer is 5% to 70% of the total wall thickness of the tube.

10. Tube according to claim 1, wherein the thickness of the barrier layer is 5% to 50% of the total wall thickness of the tube.

11. Tube according to claim 1, wherein the second carrier layer consists substantially of polyamide 6.

12. Tube according to claim 1, wherein the second carrier layer substantially consists of at least one polyamide from the group “polyamide 612, polyamide 12, polyamide 10, polyamide 11, co-polyamide 6/6.6, co-polyamide 6/12.”

13. Tube according to claim 1, wherein the thickness of the second carrier layer is 5% to 70% of the total wall thickness of the tube.

14. Tube according to claim 1, wherein the thickness of the inner layer is 5% to 55%, particularly 7% to 50% of the total wall thickness of the tube.

15. Tube according to claim 1, wherein the first carrier layer and/or the second carrier layer has/have a greater thickness than the barrier layer.

16. Tube according to claim 1, wherein the first carrier layer and/or the second carrier layer has/have a greater thickness than the inner layer.

17. Tube according to claim 1, wherein the thickness of the outer layer has a greater thickness than the barrier layer.

18. Tube according to claim 1, wherein the total layer thickness of the tube is 0.8 to 2 mm.

19. Tube according to claim 1, wherein the total layer thickness of the tube is 0.85 to 1.8 mm.
